(19) United States
(12) Patent Application Publication
(10) Pub. No.: US 2026/0092638 A1
(43) Pub. Date: Apr. 2, 2026

(54) THERMOPLASTIC BELT

(71) Applicant: Fenner, Inc. d/b/a Fenner Precision Polymers, Lititz, PA (US)

(72) Inventors: Nathan Mueller, Lititz, PA (US); Nathaniel Charles Ginder, Lititz, PA (US); Laurent Badoil, Lititz, PA (US); Fabien Pesquet, Lititz, PA (US); Grant Quincy Moyer, Lititz, PA (US)

(21) Appl. No.: 19/348,066

(22) Filed: Oct. 2, 2025

Related U.S. Application Data
(60) Provisional application No. 63/702,203, filed on Oct. 2, 2024.
(60) Provisional application No. 63/836,854, filed on Jul. 1, 2025.

(51) Int. Cl. F16G 1/14; B65G 13/07; C08L 75/06; C08L 75/08; F16G 1/06

(52) U.S. Cl. CPC F16G 1/14; B65G 13/07; C08L 75/06; C08L 75/08; F16G 1/06; C08L 2207/04

(57) ABSTRACT

A thermoplastic belt is disclosed. The belt comprises a main body having a relatively low glass transition temperature. In some embodiments, the belt maintains flexibility at about −25° C. to about −50° C. The main body may be formed as an annular ring and have a generally circular cross-sectional shape. The belt may be employed in a roller conveyor, and more particularly a roller conveyor used in a cold temperature environment such as a freezer.

### CROSS-REFERENCE TO RELATED APPLICATIONS

This application claims the benefit of U.S. Provisional Patent Application Ser. No. 63/702,203, filed Oct. 2, 2024, and 63/836,854, filed Jul. 1, 2025, the entireties of which are herein incorporated by reference.

### FIELD

The present disclosure relates to a belt for a roller conveyor, and more particularly to a thermoplastic belt for a roller conveyor.

### BACKGROUND

Roller conveyors are used in intralogistic applications for transporting goods along a pre-determined path. Such roller conveyors may be used to convey goods directly or to convey pallets, boxes or the like containing goods. A typical roller conveyor comprises a plurality of rollers rotatably mounted in a frame. The axes of rotation of the rollers may be parallel to each other for a straight conveying direction or angular to each other for a curved conveying direction.

A main advantage of such roller conveyors is the option to control a conveying action of the goods on the roller conveyor. The roller conveyor may be divided into a plurality of conveyor zones, each of which may be driven individually to affect a conveying of goods placed in the zones. For example, the roller conveyor may be controlled to convey the goods in a block mode, wherein the goods in all conveyor zones are conveyed simultaneously or in a single mode, wherein the goods in a single zone are conveyed from one zone to the adjacent downstream zone only if the adjacent downstream zone is empty.

The individual and selective control of the conveying action of the roller conveyor requires a plurality of drive units to allow the individual control. Usually, a single conveyor zone comprises a single motor driven roller and a plurality of idle rollers. The single motor driven roller is employed for effecting the conveying action. To this regard, the motor driven roller itself effects the conveying action via its circumferential surface, namely the outer roller body. Further, the motor driven roller may drive the adjacent idle rollers of the conveyor zone by a belt or O-ring at one end of the rollers.

Conventional belts are commonly fabricated from materials that exhibit a relatively high glass transition temperature (Tg). For example, the glass transition temperature (Tg) of such conventional belts is approximately −28° C., as determined using a Dynamic Mechanical Analyzer (DMA) in accordance with ASTM D4065 and E1640 standards. As a result, the conventional belts become “cold set” after being motionless or generally stationary for a period in low-temperature environments. Upon startup, the conventional belts often retain their deformed shape, preventing proper movement. This can lead to belt slippage and cause the roller conveyor to stall. Such conditions may also accelerate belt wear, increase the risk of damage, and result in significant operational downtime.

Accordingly, it would be desirable to produce a belt for a roller conveyor having a broader thermal range and capable of performing across various temperatures and environments.

### SUMMARY

In concordance and agreement with the presently described subject matter, a belt for a roller conveyor having a broader thermal range and capable of performing across various temperatures and environments, has been newly designed.

In one embodiment, a belt, comprises: a main body produced from a material composition exhibiting a relatively low glass transition temperature is in a range of about −30° C. to about-50° C.

As aspects of some embodiments, the main body is a continuous annular ring.

As aspects of some embodiments, a circumference of the main body is less than about 18 inches.

As aspects of some embodiments, a cross-sectional shape of the main body is one of circular, elliptical, triangular, rectangular, or irregular.

As aspects of some embodiments, a diameter of the main body is less than about 0.5 inches.

As aspects of some embodiments, the material composition comprises at least one thermoplastic material.

As aspects of some embodiments, the at least one thermoplastic material is selected from a group comprising one or more polyester based thermoplastic elastomer materials and/or one or more polyether based thermoplastic elastomer materials.

As aspects of some embodiments, the material composition comprises at least one thermoplastic material and at least one elastomeric additive material.

As aspects of some embodiments, the material composition comprises about 95% by total weight of the at least one thermoplastic material and about 5% by total weight of the at least one elastomeric additive material.

As aspects of some embodiments, the at least one thermoplastic material is one or more thermoplastic elastomers.

As aspects of some embodiments, the at least one thermoplastic material is one or more thermoplastic polyurethanes.

As aspects of some embodiments, the at least one elastomeric additive material is one or more rubber powders.

As aspects of some embodiments, the one or more rubber powders is at least one micronized rubber powder.

As aspects of some embodiments, the at least one micronized rubber powder has a particle size of 50 mesh or smaller.

As aspects of some embodiments, the at least one micronized rubber powder has a particle size of 140 mesh or smaller.

As aspects of some embodiments, the at least one micronized rubber powder has a particle size of 200 mesh or smaller.

As aspects of some embodiments, the main body is configured to drivingly connect a roller of a roller conveyor to an adjacent roller of the roller conveyor.

As aspects of some embodiments, the main body is configured to be received in a groove formed in the roller of the roller conveyor.

As aspects of some embodiments, the main body includes one or more surface irregularities provided on an outer surface thereof.

As aspects of some embodiments, the main body includes one or more surface treatments applied to an outer surface thereof.

Further areas of applicability will become apparent from the description provided herein. The description and specific examples in this summary are intended for purposes of illustration only and are not intended to limit the scope of the present disclosure.

### BRIEF DESCRIPTION OF THE DRAWINGS

The drawings described herein are for illustrative purposes only of selected embodiments and

not all possible implementations, and are not intended to limit the scope of the present disclosure.

FIG. 1 is a perspective view of a belt for a roller conveyor according to an embodiment of the present disclosure;

FIG. 2 is a front view of the belt of FIG. 1;

FIG. 3 is a cross-sectional view of the belt of FIGS. 1 and 2;

FIG. 4 is a cross-sectional view of the belt of FIGS. 1-3, wherein the belt includes one or

more surface irregularities provided on an outer surface thereof;

FIG. 5 is a cross-sectional view of the belt of FIGS. 1-3, wherein the belt includes a surface treatment provided on an outer surface thereof;

FIG. 6 is a perspective view of a roller conveyor including a plurality of the belts of FIGS. 1-3;

FIG. 7 is an enlarged perspective view of a portion of the roller conveyor of FIG. 6 including the belts of FIGS. 1-3; and

FIG. 8 is a graph showing a startup slip over a time period for a belt of the present disclosure including micronized rubber powder and a belt of the present disclosure with a low glass transition temperature (Tg) of −35.6° C. compared to a conventional belt with a high glass transition temperature (Tg) of −28.7° C.

### DETAILED DESCRIPTION

The following description of technology is merely exemplary in nature of the subject matter, manufacture and use of one or more embodiments, and is not intended to limit the scope, application, or uses of any specific embodiment claimed in this application or in such other applications as may be filed claiming priority to this application, or patents issuing therefrom. Regarding methods disclosed, the order of the steps presented is exemplary in nature, and thus, the order of the steps can be different in various embodiments. “A” and “an” as used herein indicate “at least one” of the item is present; a plurality of such items may be present, when possible. Except where otherwise expressly indicated, all numerical quantities in this description are to be understood as modified by the word “about” and all geometric and spatial descriptors are to be understood as modified by the word “substantially” in describing the broadest scope of the technology. “About” when applied to numerical values indicates that the calculation or the measurement allows some slight imprecision in the value (with some approach to exactness in the value; approximately or reasonably close to the value; nearly). If, for some reason, the imprecision provided by “about” and/or “substantially” is not otherwise understood in the art with this ordinary meaning, then “about” and/or “substantially” as used herein indicates at least variations that may arise from ordinary methods of measuring or using such parameters.

All documents, including patents, patent applications, and scientific literature cited in this detailed description are incorporated herein by reference, unless otherwise expressly indicated. Where any conflict or ambiguity may exist between a document incorporated by reference and this detailed description, the present detailed description controls.

Although the open-ended term “comprising,” as a synonym of non-restrictive terms such as including, containing, or having, is used herein to describe and claim embodiments of the present technology, embodiments may alternatively be described using more limiting terms such as “consisting of” or “consisting essentially of.” Thus, for any given embodiment reciting materials, components, or process steps, the present technology also specifically includes embodiments consisting of, or consisting essentially of, such materials, components, or process steps excluding additional materials, components or processes (for consisting of) and excluding additional materials, components or processes affecting the significant properties of the embodiment (for consisting essentially of), even though such additional materials, components or processes are not explicitly recited in this application. For example, recitation of a composition or process reciting elements A, B and C specifically envisions embodiments consisting of, and consisting essentially of, A, B and C, excluding an element D that may be recited in the art, even though element D is not explicitly described as being excluded herein.

As referred to herein, all compositional percentages are by weight of the total composition, unless otherwise specified. Disclosures of ranges are, unless specified otherwise, inclusive of endpoints and include all distinct values and further divided ranges within the entire range. Thus, for example, a range of “from A to B” or “from about A to about B” is inclusive of A and of B. Disclosure of values and ranges of values for specific parameters (such as amounts, weight percentages, etc.) are not exclusive of other values and ranges of values useful herein. It is envisioned that two or more specific exemplified values for a given parameter may define endpoints for a range of values that may be claimed for the parameter. For example, if Parameter X is exemplified herein to have value A and also exemplified to have value Z, it is envisioned that Parameter X may have a range of values from about A to about Z. Similarly, it is envisioned that disclosure of two or more ranges of values for a parameter (whether such ranges are nested, overlapping or distinct) subsume all possible combination of ranges for the value that might be claimed using endpoints of the disclosed ranges. For example, if Parameter X is exemplified herein to have values in the range of 1-10, or 2-9, or 3-8, it is also envisioned that Parameter X may have other ranges of values including 1-9, 1-8, 1-3, 1-2, 2-10, 2-8, 2-3, 3-10, 3-9, and so on.

When an element or layer is referred to as being “on,” “engaged to,” “connected to,” or “coupled to” another element or layer, it may be directly on, engaged, connected or coupled to the other element or layer, or intervening elements or layers may be present. In contrast, when an element is referred to as being “directly on,” “directly engaged to,” “directly connected to” or “directly coupled to” another element or layer, there may be no intervening elements or layers present. Other words used to describe the relationship between elements should be interpreted in a like fashion (e.g., “between” versus “directly between,” “adjacent” versus “directly adjacent,” etc.). As used herein, the term “and/or” includes any and all combinations of one or more of the associated listed items.

Although the terms first, second, third, etc. may be used herein to describe various elements, components, regions, layers and/or sections, these elements, components, regions, layers and/or sections should not be limited by these terms. These terms may be only used to distinguish one element, component, region, layer or section from another region, layer or section. Terms such as “first,” “second,” and other numerical terms when used herein do not imply a sequence or order unless clearly indicated by the context. Thus, a first element, component, region, layer or section discussed below could be termed a second element, component, region, layer or section without departing from the teachings of the example embodiments.

Spatially relative terms, such as “inner,” “outer,” “beneath,” “below,” “lower,” “above,” “upper,” and the like, may be used herein for ease of description to describe one element or feature's relationship to another element(s) or feature(s) as illustrated in the figures. Spatially relative terms may be intended to encompass different orientations of the device in use or operation in addition to the orientation depicted in the figures. For example, if the device in the figures is turned over, elements described as “below” or “beneath” other elements or features would then be oriented “above” the other elements or features. Thus, the example term “below” can encompass both an orientation of above and below. The device may be otherwise oriented (rotated 90 degrees or at other orientations) and the spatially relative descriptors used herein interpreted accordingly.

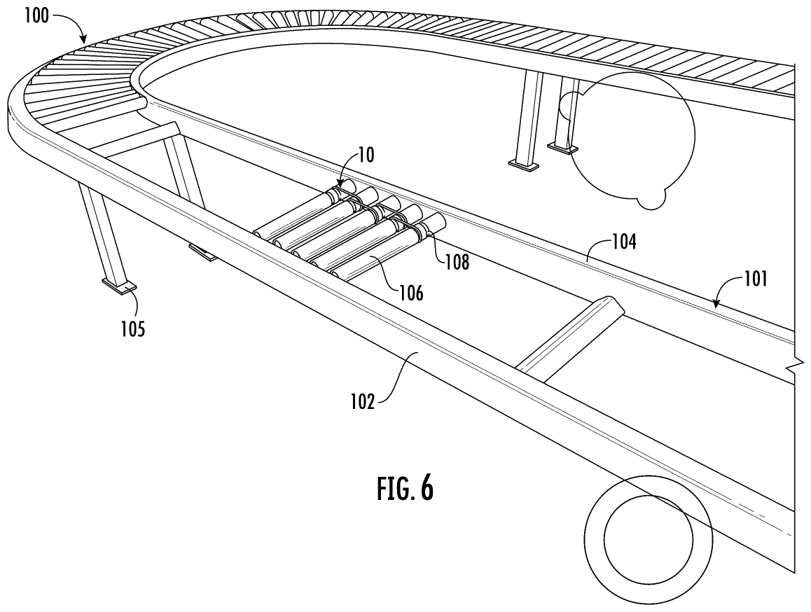

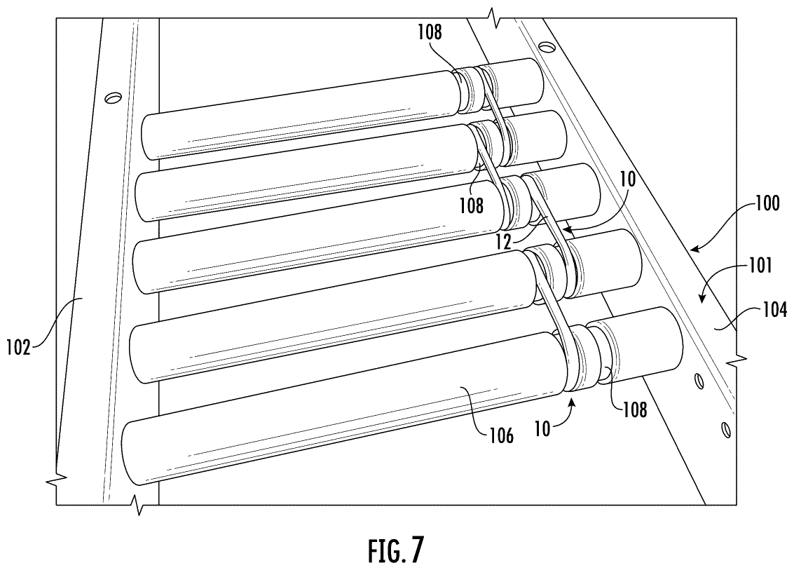

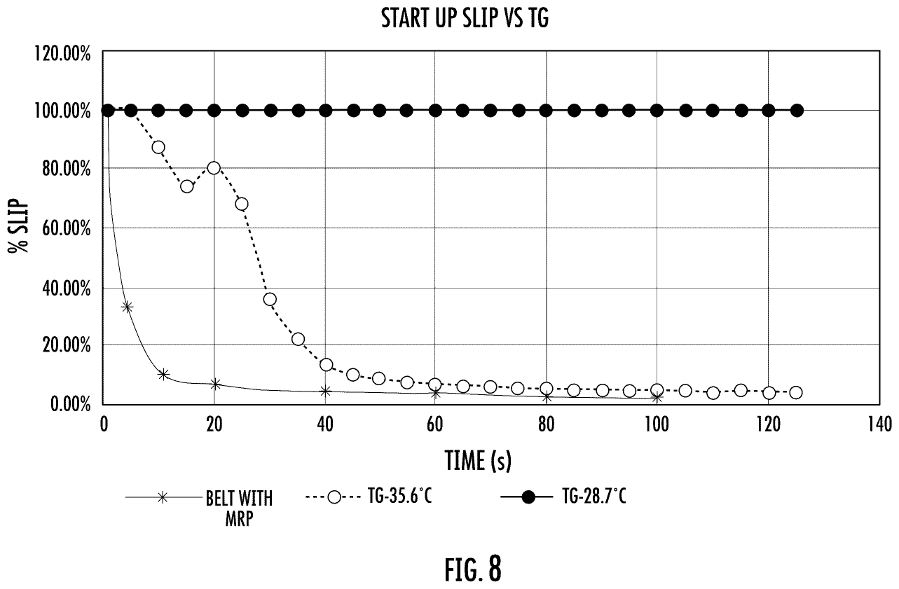

FIGS. 1-5 illustrate a belt 10 according to exemplary embodiments of the present disclosure. Preferably, the belt 10, as shown in FIGS. 6 and 7, may be configured for a conveyor system 100. It is understood, however, that the belt 10 may be employed in other applications as desired.

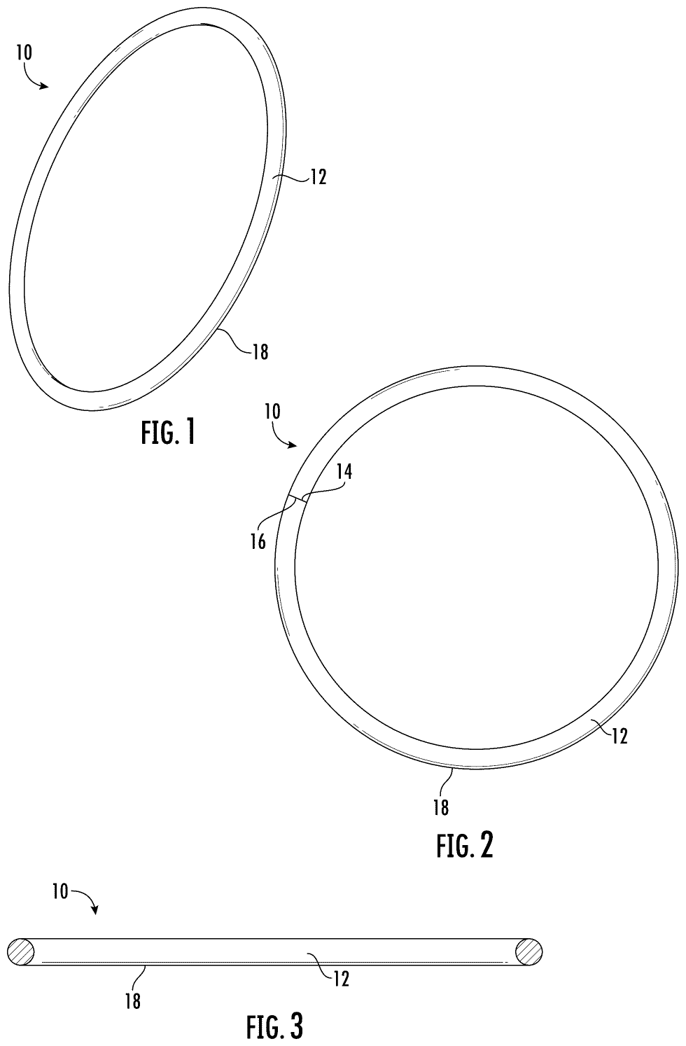

In some embodiments, the belt 10 comprises a main body 12. The main body 12 may be a continuous band with no interruptions as shown in FIG. 1. In some instances, however, as depicted in FIG. 2, peripherally abutting edges 14, 16 of the main body 12 are coupled together to form an annular ring. It is understood that the edges 14, 16 may be coupled together by any suitable method such as heat and/or pressure sealing, for example. In certain embodiments, the main body 12 may also have a generally circular cross-sectional shape as shown in FIG. 3. In other embodiments, however, the main body 12 may have various other cross-sectional shapes as desired. For example, the main body 12 may have an elliptical, triangular, rectangular, or irregular cross-sectional shape. It is understood that the cross-sectional shape of the belt 10 may be uniform or vary along the main body 12. A circumference of the main body 12 may be determined based upon the application of the belt 10. For example, for a roller conveyor, the circumference of the main body 12 may be less than about 18 inches.

The main body 12 may also have a substantially uniform thickness or diameter. In specific instances, the main body 12 can have a diameter in a range of about 0.1 inches to about 0.5 inches, preferably in a range of about 0.15 inches to about 0.4 inches, and more preferably, a diameter of about 0.1875 inches, about 0.21 inches, or about 0.235 inches. The thickness and/or the diameter of the main body 12 may be increased or decreased based upon the application for which the belt 10 is employed. An environment temperature of the application impacts the thickness and/or the diameter of the main body 12. In certain embodiments, the thickness and/or the diameter of the main body 12 is increased as the environment temperature is decreased.

According to the present disclosure, the main body 12 is produced from an elastomeric material having a low glass transition temperature (Tg). The glass transition temperature (Tg) refers to a temperature at which a polymer material transitions from a rubbery or viscous state to a rigid, glassy state. This physical change is brought on by the fact that polymer chains become less mobile as the temperature decreases. In preferred embodiments, the glass transition temperature (Tg) of the main body 12 is in a range of about −25° C. to about −50° C. as determined using a Dynamic Mechanical Analyzer (DMA) in accordance with ASTM D4065 and E1640 standards. In certain embodiments, the glass transition temperature (Tg) of the main body 12 is in a range of about −30° C. to about −40° C., particularly about −35° C., and more particularly about −35.6° C. With this glass transition temperature (Tg), the main body 12 maintains flexibility and avoids “cold set” after remaining motionless for a time period.

In some embodiments, the main body 12 may be formed from a composition comprising at least one thermoplastic material and at least one elastomeric additive material. An exemplary composition formulation comprises about 95% by total weight of one or more thermoplastic materials and about 5% by total weight of one or more elastomeric additive materials. It is understood that the composition may include various ratios of the one or more thermoplastic materials to the one or more elastomeric additive materials, depending on the specific materials selected and the desired performance characteristics.

In some embodiments, the at least one thermoplastic material used in the composition to form the main body 12 may be selected from a group comprising one or more thermoplastic elastomers (TPE) and/or one or more thermoplastic polyurethanes (TPU). In certain embodiments, one or more polyester based TPE materials or one or more polyether based TPE materials may be employed. For example, the TPE materials known as Hytrel® made by Dupont™, Kraton™ made by Kraton Corporation, a wholly owned subsidiary of DL Chemical Co., Ltd, Sarlink® made by Teknor Apex, and Arnitel® made by Envalior. In such embodiments, the glass transition temperature (Tg) of the main body 12 is in a range of about-40° C. to about −50° C., particularly about −45° C., and more particularly about −43.7° C.

In some embodiments, the at least one elastomeric additive material may be one or more rubber powders, and more particularly, one or more micronized rubber powders (MRP). The MRPs may be made from at least one vulcanized elastomeric material, most often from end-of-life tire material, but can also be produced from one or more materials selected from a group comprising post-industrial nitrile rubber, ethylene propylene diene monomer (EPDM), butyl and natural rubber compounds. It should be appreciated that the rubber powder may have any suitable particle size such as 50 mesh or smaller, preferably 140 mesh or smaller, and more preferably 200 mesh or smaller. In certain instances, a particle size of 80 mesh is preferred. The term “mesh” refers to the number of openings per linear inch in a screen or sieve, and is commonly used to describe particle size of powders and granular materials. A higher mesh number is equal to smaller particles, and a lower mesh number is equal to larger particles. For example, a particle size of 10 mesh is approximately 2000 microns; 50 mesh is approximately 297 microns; 100 mesh is approximately 149 microns; 200 mesh is approximately 74 microns; and 400 mesh is approximately 37 microns. The one or more elastomeric additive materials provide improved grip of the belt 10, especially in environments with frost, and redefines a compromise between the transition temperature and a storage modulus of the belt 10.

The one or more thermoplastic materials can be blended, mixed, or otherwise combined with the one or more elastomeric additive materials by any conventional method. The material composition may then be formed into the main body 12 of the belt 10 in accordance with any suitable techniques, methods, and the like.

In other certain embodiments, the main body 12 may be formed from a composition comprising the one or more thermoplastic materials without the one or more elastomeric additive materials.

Advantageously, the material composition used to produce the belt 10 exhibits mechanical and physical properties such as exceptional toughness and resilience, high resistance to creep, impact and flex fatigue, and preferably flexibility at low temperatures (i.e., low glass transition temperature) and good retention of properties at various temperatures. Thus, the shape of the main body 12 may be altered without changing an overall form (i.e., elastomeric memory). This limits the wear and damage to the belt 10 during use while maintaining the same load capacity. In addition, the material composition of the belt 10 resists many industrial chemicals, oils, and solvents; thus, is suitable across many applications including, but not limited to, use in a roller conveyor.

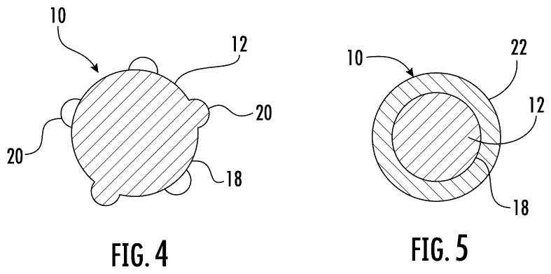

As shown, the main body 12 may also have a generally smooth outer surface 18. In some embodiments shown in FIG. 4, however, that the outer surface 18 may include one or more surface irregularities 20. The one or more surface irregularities 20 may be one or more friction features (e.g., protuberances, indentations, grooves, ribs, and the like) if desired. In other embodiments shown in FIG. 5, a surface treatment 22 such as a coating, for example, may be applied to the outer surface 18 of the main body 12 forming a core and shell structure if desired for certain applications. In some embodiments, the core or main body 12 of the belt 10 may be produced from the composition comprising the one or more thermoplastic materials without the one or more elastomeric additive materials, and the shell or surface treatment 22 may be produced from the composition comprising the one or more thermoplastic materials and the one or more elastomeric additive materials.

As illustrated in FIGS. 6 and 7, the belt 10 is well-suited for a roller conveyor 100. In some embodiments, the roller conveyor 100 includes a frame structure 101 comprising a first member 102 and a spaced apart second member 104 supported by one or more base members 105. A plurality of rollers 106 are rotatably disposed between the first and second members 102, 104. As best seen in FIG. 5, each of the rollers 106 may include at least one annular groove 108 formed therein. The annular groove 108 is configured to receive one or more belts 10 therein. As illustrated, the belts 10 are configured to drivingly connect each of the rollers 106 to an adjacent one of the rollers 106. Accordingly, when one of the rollers 106 is caused to move in either a first rotational direction (e.g., clockwise) or an opposite second rotational direction (e.g., counterclockwise), the movement is transmitted through the belts 10 so that the remaining rollers 106 are also caused to move in the same rotational direction. The belt 10 of the present disclosure is less susceptible to “cold-set” and maintains its flexibility, and thereby movement, in a relatively cold temperature environment (e.g., a freezer). Therefore, continued operation of the roller conveyor may be achieved even after remaining motionless for a period.

Advantageously, the belt 10 of the present disclosure performs better and is more reliable and durable than conventional belts, resulting in reduced maintenance and downtime. In some instances, the belt 10 for the roller conveyor may last at least 3-4× longer than the conventional belts.

To demonstrate the effect of glass transition temperature (Tg) on belt flexibility and resistance to cold setting, a comparative experiment was conducted. The objective was to evaluate the time required for a belt to initiate rotation after prolonged exposure to sub-zero conditions.

In an example, three belt materials were tested: a low glass transition temperature (Tg) thermoplastic polyurethane belt 10 of the present disclosure including the MRP, a low glass transition temperature (Tg) thermoplastic polyurethane belt 10 of the present disclosure (i.e., a −35.6° C. Tg), and a conventional higher (Tg) thermoplastic polyurethane belt (i.e., a −28.7° C. Tg). Each of the belts 10 and the convention belt was installed on a roller conveyor system powered by a motorized drive roller. The system included load cells configured to apply and measure a torque load of 1 ft-lb on one of the rollers. The belts 10 and the conventional belt were installed with 8% elongation and remained stationary in a freezer at −40° C. for a minimum of 16 hours to induce cold setting.

The rollers used in the test had a diameter of 1.9 inches. Rotational speeds of the rollers were monitored using tachometers, and the difference in revolutions per minute (RPM) between the two rollers was used to calculate the percentage of belt slip. The time required for each of the belts 10 and the conventional belt to begin revolving under the applied torque was recorded.

The results, illustrated in the graph of FIG. 6, show that the belts 10 of the present disclosure with the MRP and/or the low glass transition temperature (Tg) resumed motion significantly faster and exhibited less slip compared to the conventional belt with the high glass transition temperature (Tg). Specifically, the belts 10 initiate movement at approximately 5-10 seconds, whereas the conventional belt remains stationary and fails to begin movement. Accordingly, the belts 10, with the MRP and/or the low glass transition temperature (Tg), maintain flexibility and resists cold setting more effectively under extreme cold conditions.

Example embodiments are provided so that this disclosure will be thorough, and will fully convey the scope to those who are skilled in the art. Numerous specific details are set forth such as examples of specific components, devices, and methods, to provide a thorough understanding of embodiments of the present disclosure. It will be apparent to those skilled in the art that specific details need not be employed, that example embodiments may be embodied in many different forms, and that neither should be construed to limit the scope of the disclosure. In some example embodiments, well-known processes, well-known device structures, and well-known technologies are not described in detail. Equivalent changes, modifications and variations of some embodiments, materials, compositions and methods can be made within the scope of the present technology, with substantially similar results.

What is claimed is:

1. A belt, comprising:
a main body produced from a material composition exhibiting a relatively low glass transition temperature in a range of about −30° C. to about −50° C.

2. The belt of claim 1, wherein the main body is a continuous annular ring.

3. The belt of claim 1, wherein a circumference of the main body is less than about 18 inches.

4. The belt of claim 1, wherein a cross-sectional shape of the main body is one of circular, elliptical, triangular, rectangular, or irregular.

5. The belt of claim 1, wherein a diameter of the main body is less than about 0.5 inches.

6. The belt of claim 1, wherein the material composition comprises at least one thermoplastic material.

7. The belt of claim 6, wherein the at least one thermoplastic material is selected from a group comprising one or more polyester based thermoplastic elastomer materials and/or one or more polyether based thermoplastic elastomer materials.

8. The belt of claim 1, wherein the material composition comprises at least one thermoplastic material and at least one elastomeric additive material.

9. The belt of claim 8, wherein the material composition comprises about 95% by total weight of the at least one thermoplastic material and about 5% by total weight of the at least one elastomeric additive material.

10. The belt of claim 8, wherein the at least one thermoplastic material is one or more thermoplastic elastomers.

11. The belt of claim 8, wherein the at least one thermoplastic material is one or more thermoplastic polyurethanes.

12. The belt of claim 8, wherein the at least one elastomeric additive material is one or more rubber powders.

13. The belt of claim 12, wherein the one or more rubber powders is at least one micronized rubber powder.

14. The belt of claim 13, wherein the at least one micronized rubber powder has a particle size of 50 mesh or smaller.

15. The belt of claim 13, wherein the at least one micronized rubber powder has a particle size of 140 mesh or smaller.

16. The belt of claim 13, wherein the at least one micronized rubber powder has a particle size of 200 mesh or smaller.

17. The belt of claim 1, wherein the main body is configured to drivingly connect a roller of a roller conveyor to an adjacent roller of the roller conveyor.

18. The belt of claim 17, wherein the main body is configured to be received in a groove formed in the roller of the roller conveyor.

19. The belt of claim 1, wherein the main body includes one or more surface irregularities provided on an outer surface thereof.

20. The belt of claim 1, wherein the main body includes one or more surface treatments applied to an outer surface thereof.
